(19) United States
(12) Patent Application Publication
(10) Pub. No.: US 2008/0131036 A1
(43) Pub. Date: Jun. 5, 2008

(54) Linear Roller Bearing Comprising A U-Shaped Scraper Element On The End Face Of A Guide Carriage

(75) Inventors: Peter Keller, Bruchmuehlbach-Miesau (DE); Dietmar Rudy, Kleinbundenbach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/814,848

(22) PCT Filed: Dec. 17, 2005
(86) PCT No.: PCT/EP05/13636

§ 371 Date: Aug. 15, 2007

(30) Foreign Application Priority Data
Jan. 27, 2005 (DE) 10 2005 003 874.3

(51) Int. Cl. F16C 29/08

(52) U.S. Cl. 384/15

(57) ABSTRACT

Linear rolling bearing, having a guide carriage (2) which is mounted by means of rolling bearings on a guide rail (1), and having a scraper (3), arranged at at least one of the two end sides of the guide carriage (2), for scraping foreign objects such as chips, dust and cooling liquids from the guide rail, with the scraper (3) being in scraping contact, by means of its scraping system (16), preferably sealing lip (16a) or sealing edge, with the guide rail (1), wherein the scraper (3) has a housing (17) which optionally holds one or more preferably plate-shaped, removable seals (18), with the seal (18) being provided with the scraping system (16).

The present invention relates to a linear rolling bearing, having a guide carriage which is mounted by means of rolling bearings on a guide rail.

U.S. Pat. No. 5,590,965 A for example has disclosed a linear rolling bearing in which a guide carriage, which is of approximately u-shaped design, is mounted by means of rolling bearings on a guide rail. The u-shaped guide carriage engages with its two limbs around the guide rail. Arranged at the two end sides of the guide carriage are scrapers for scraping away foreign objects such as chips, dust and cooling liquids. Said scrapers are in scraping contact, by means of their sealing lips or sealing edges, with the longitudinal sides and with the upper side of the guide rail. The foreign objects are removed from the guide rail by means of said scrapers before the guide carriage reaches these points. Depending on the application, it is possible for scrapers having one or more sealing edges or sealing lips to be provided.

It is an object of the present invention to specify a linear rolling bearing according to the features of the preamble of claim 1, in which protection, which is sufficient for the respective application, against the infiltration of undesired foreign objects into the guide carriage, in particular into the region of raceways for the rolling bodies, is ensured in a simple manner.

According to the invention, said object is achieved in that the scraper has a housing which optionally holds one or more plate-shaped, removable seals, with the seal being provided with the scraping system. A common housing can advantageously be provided for the widest variety of applications. The housing is dimensioned to be so large that one or more plate-shaped seals can be inserted into the housing so as to be arranged one behind the other in the axial direction. A further advantage is that, in the case of worn sealing lips or sealing edges, it is not necessary for the entire scraper to be replaced; it is sufficient for only the worn seals to be removed from the housing and replaced with new seals. This exchange of the seals is therefore economically advantageous.

The guide carriage is preferably of unshaped design and engages with its two limbs around the guide rail. The scraper is then preferably in scraping contact with the longitudinal sides and with the upper side of the guide rail.

The housing, which can be fastened in a detachable manner to the guide carriage, is of approximately u-shaped design and engages with its two limbs around the guide rail. The housing can be removed transversely with respect to the guide rail, preferably upward. This arrangement offers the advantage that, in the event that a seal exchange is to be carried out, it is not necessary for the entire guide carriage to be removed from the guide rail. It is in fact sufficient for the scraper to be detached from the guide carriage. The complete scraper can then be removed upward from the guide rail, so that the seal exchange can be carried out in a simple manner as described.

In the case of linear rolling bearings, the guide rail often has, at its two end sides, in each case two raceways for rolling bodies, for example ball grooves. The two ball grooves are then formed on the guide rail with a parallel spacing to one another; the ball grooves and/or the casing section between said two ball grooves can then be situated within the greatest width of the guide rail. Since the seals bear by means of their scraping systems against the ball grooves and against said casing section, said seals cannot be pulled upward from the guide rail because the clear spacing between the scraping systems, which are formed on the two limbs, of the seals is then smaller than the width of the guide rail. In this case, the housing, which is open in the direction of the guide rail, can be pulled upward without the seals, and the seals initially remain on the guide rail. The seals, which are formed from flexible material, can be easily bent such that they can be removed from the guide rail and replaced with new seals. The housing can then be placed back on again.

The housing is preferably made from sheet metal in a shaping process. As viewed in longitudinal section through the guide carriage, said housing has an approximately unshaped section profile which is open toward the guide rail. The two limb parts then form a front wall and a rear wall of the housing, with a base part, which connects the two limb parts, forming a peripheral wall of the housing. The plate-shaped seals can be supported against said walls.

If for example only one seal is installed into the housing which is also suitable for a plurality of seals, it can be expedient to take measures in order to keep said plate-shaped seal stable and in the correct position. This applies all the more since seals are often produced from a flexible elastic material. For the case that only a single seal is installed in the housing, said seal generally bears either against the front wall or against the rear wall of the housing. The in each case other side of the seal is not supported. One refinement according to the invention therefore provides a rigid support plate as a support for the seal which is formed from flexible material, with said support plate being inserted into the housing. For positionally accurate alignment of the support plate, the housing can be provided with a first receptacle, so that the support plate is held correctly in all spatial axes.

Furthermore, the housing can have a second receptacle for the positionally accurate alignment of the seal in all spatial axes. This refinement offers the advantage of further additional support of the seal which is produced in particular from flexible material. A further technical measure for the correct positioning of the support plate and of the seal relative to one another provides that the support plate and the seal engage into one another in a form-fitting manner at least one point. As a form-fitting connection, it is possible for example for a projection which is provided on the support plate to engage into a corresponding recess of the seal. The recess and the projection are then formed with fitting accuracy with respect to one another.

The invention is explained in more detail below on the basis of an exemplary embodiment which is depicted in a total of four figures, in which:

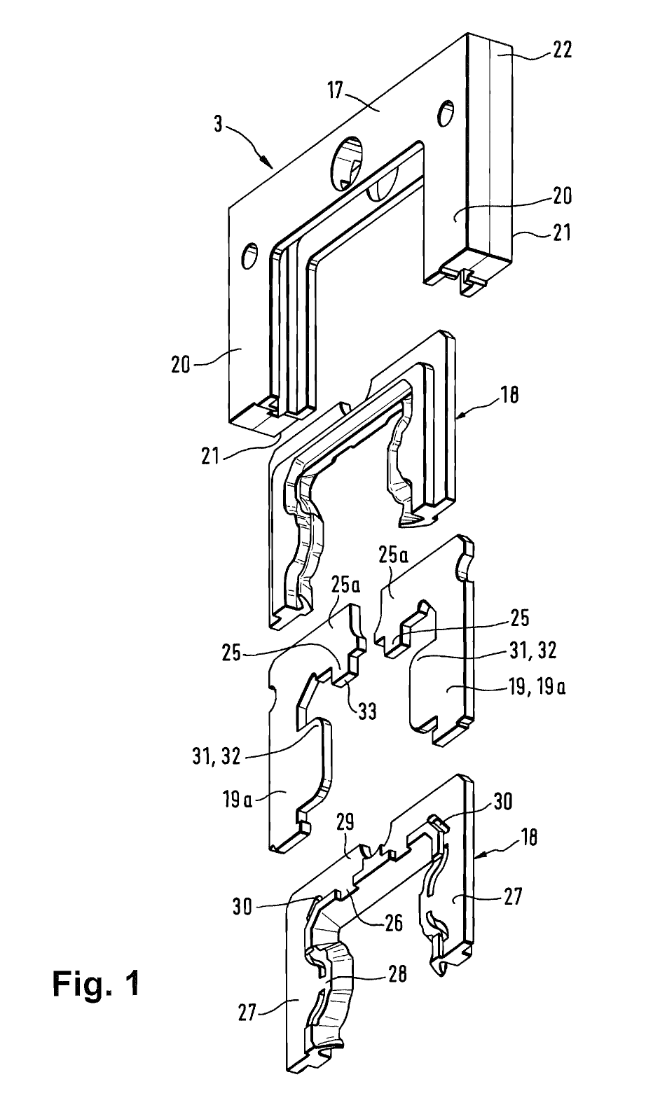

FIG. 1 shows a scraper according to the invention in an exploded illustration,

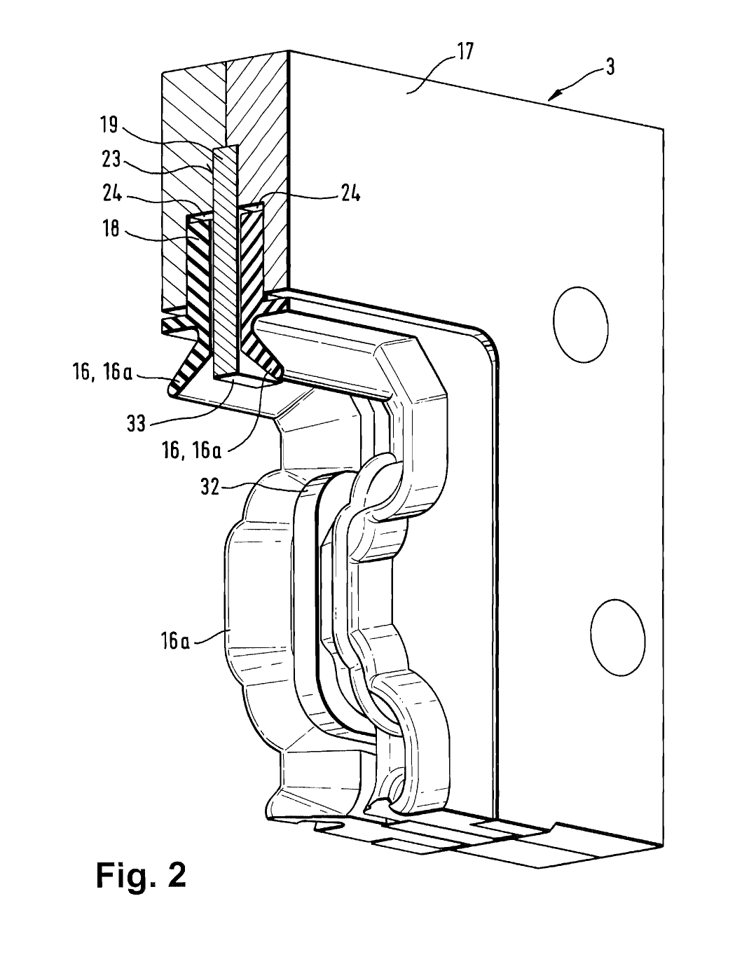

FIG. 2 shows the scraper from FIG. 1 in a perspective illustration and in section,

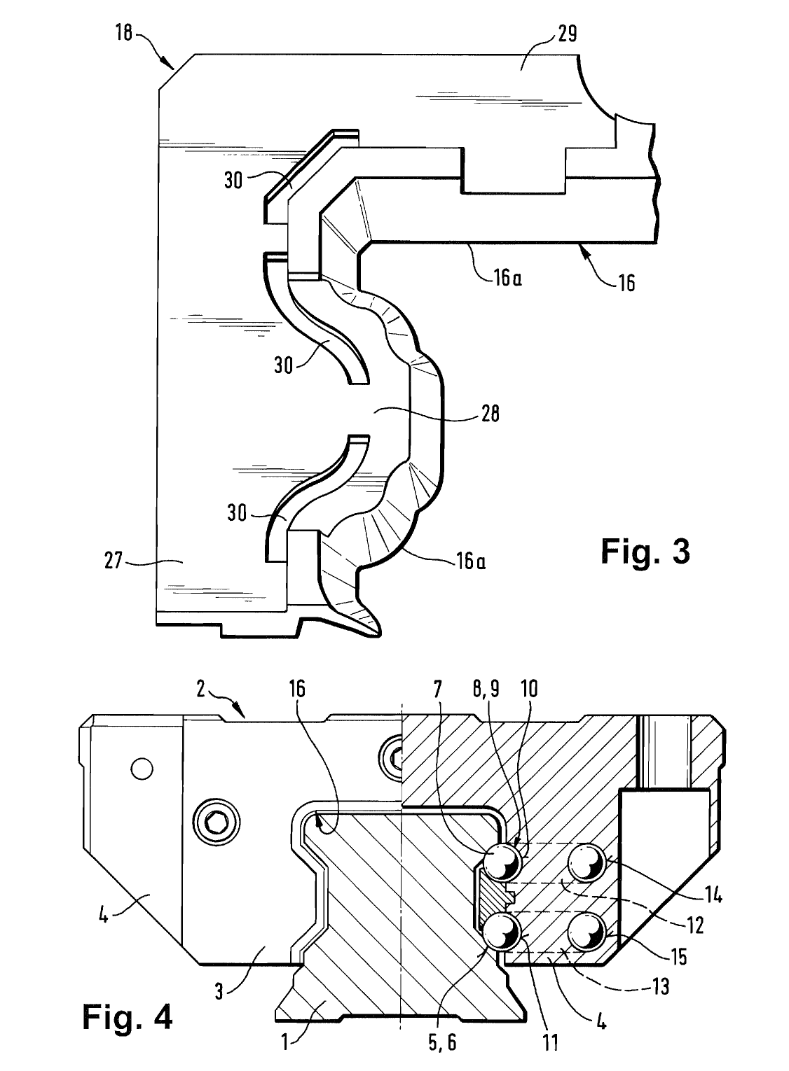

FIG. 3 shows a seal of the scraper as per FIG. 2 in a perspective and enlarged illustration, and

FIG. 4 shows a linear rolling bearing according to the invention, partially in section.

### DETAILED DESCRIPTION OF THE DRAWING

The linear rolling bearing according to the invention depicted in FIG. 4 has a guide carriage 2 which is guided in a longitudinally moveable manner on a guide rail 1. Scrapers 3 are detachably fastened to both end sides of the guide carriage 2. The guide carriage 2 has a substantially unshaped profile. The guide carriage 2 engages with its two limbs 4 around the guide rail 1.

The guide rail 1 has an upper side and, situated opposite one another, two longitudinal sides, with the longitudinal sides being provided in each case with a plurality of raceways 6, which are formed by ball grooves 5, for balls 7. The four ball grooves 5 of the guide rail 1 are arranged in an O-arrangement with one another.

The guide carriage 2 has, on its two limbs 4 on its sides which face toward the longitudinal sides of the guide rail 1, in each case two raceways 8 which face the raceways 6 and are likewise formed as ball grooves 9. The ball grooves 5, 9 of the guide rail 1 and of the guide carriage 2 delimit first and second load channels 10, 11 in which the balls 7 roll under load on the ball grooves 5, 9. Deflecting channels 12, 13 and return channels 14, 15, which are indicated by dashed lines, connect the start and end of the load channels 10, 11 to one another in a continuous manner.

If tensile forces engage on the guide carriage 2, which pull the guide carriage 2 upward away from the guide rail 1, the balls 7 of the first load channels 10 transmit the load. The load channel 10 accordingly has a tension raceway. If compressive forces act on the guide carriage 2, the second load channels transmit the load. The load channel 11 accordingly has a compression raceway.

The scraper 3 is provided at its inner periphery with a scraping system 16 which is formed in the present case by a sealing lip 16a, as can be seen in particular from FIG. 2 which is described further below. The scraping system 16 is matched to the contour of the guide rail 1. The scraper 3 is in scraping contact, by means of its scraping system 16, with the upper side and with the two longitudinal sides of the guide rail 1.

The scraper 3 will now be described in detail below on the basis of FIGS. 1 to 3. FIG. 1 shows the individual parts of the scraper 3 according to the invention. In a housing 17, two plate-shaped seals 18, which are formed from flexible material, are arranged in series in the rail direction. Arranged between the two seals 18 is a support plate 19 against which the two seals 18 are supported by means of their sides which face toward the support plate 19.

The housing 17, as viewed in longitudinal section through the guide carriage 2, has an approximately u-shaped section profile which is open toward the guide rail 1. The two limb parts 20, 21 of said section profile form a front wall and a rear wall of the housing 17, with the rear wall facing toward the guide carriage 2. A base part 22, which connects the two limb parts 20, 21, forms a peripheral wall of the housing 17.

The housing 17 is provided with a first receptacle 23 for the support plate 19. When the support plate 19 is arranged correctly in the first receptacle 23, the support plate 19 is aligned positionally accurately in all spatial axes. FIG. 2 shows the first receptacle 23 with a rectangular cross section, with said first receptacle 23 being formed both in the base part 23 and also in the limb parts 20, 21.

The housing 17 is also provided with a second receptacle 24 for the two seals 18. The two second receptacles 24 are likewise depicted in FIG. 2. The second receptacles 24 are also formed here as rectangular recesses both in the base part 22 and in the limb parts 20, 21. When the seals 18 are held correctly in said second receptacles 24, said seals 18 are aligned positionally accurately in all spatial axes. The seals 18 are supported with their one end side on the front wall and on the rear wall of the housing 17, and with their other end side on the support plate 19. Even if one of the two seals 18 is removed, it is therefore ensured that the other, remaining seal 18 is held correctly and positionally accurately in the housing 17.

The plate-shaped seals 18 can be easily removed from the housing 17 and replaced with other seals. If the guide carriage 2 with the mounted scraper 3 is arranged on the guide rail 1, it is necessary merely for the scraper 3 to be detached from the guide carriage 2. The housing 17 of the scraper 3 can then be removed from the guide rail 1 upward. The two seals 18 and the support plate 19 can initially remain on the guide rail 1. Since the two seals 18 are preferably formed from a flexible material, said seals can be bent such that they can be removed from the guide rail 1. New seals can then be placed on, and the housing can be placed back on again.

The seals 18 and the support plate 19 are additionally connected to one another in a form-fitting manner. As can be seen from FIG. 1, the support plate 19 is provided with two projections 25. The two projections 25 are formed in each case on a transverse web 25a of the limb 19a of the support plate 19. The two seals 18 are provided with in each case two recesses 26, with the projections 25 of the support plate 19 engaging into the recesses 26 of the two seal. The depth of the recesses 26 is approximately half of the thickness of the support plate 19. Since the two seals 18 are arranged to both sides of the support plate 19, it is accordingly possible for the two projections 25 of the support plate 19 to engage both into the recesses 26 of the one and of the other seal 18. The support plate 19, which in the present case is of two-part design, can also be of single-part design. The two transverse webs 25a of the support plate 19 are then connected to one another in one piece.

In the four-row linear rolling bearing with an O-arrangement illustrated here, the ball grooves 5, 9 on the guide rail 1 are arranged in such a way that the two limbs 27 of the seal 18, which is of unshaped design, are provided at their sides which face toward one another in each case with a projecting lug 27. FIG. 3 shows a part of the seal 18 in a perspective illustration with the lug 28. It can also be clearly seen from said figure that the sealing lip 16a is matched to the contour of the guide rail 1, so that the sealing lip 16a is correctly in scraping contact with the guide rail 1.

Between the lug 28 and the transverse web 29, which connects the two limbs 27, of the seal 18, the sealing lip 16a undergoes pronounced deflections along its contour. In this way, shape-related points of increased stiffness are formed along the extent of the sealing lip 16a. Since it is however advantageous if the contact pressure of the sealing lip 16a against the guide rail 1 is uniform, targeted material weakenings are provided on the seal 18 at said points of increased stiffness. Said targeted material weakenings are formed in the exemplary embodiment in that, at the points of increased stiffness, a plurality of recesses are provided, which recesses extend through the seal 18 and form slots 30. Said slots 30 are arranged at a small distance from the sealing lips 16a. The sealing lips 16a are accordingly not supported at said points, and can be compressed resiliently in the direction of the slots 30. It is possible in this way to ensure uniform pressure of the sealing lip 16a along the entire extent in a targeted manner.

Said slots 30 are provided both in the region of the lugs 28 and in the region of corners which are formed by the two limbs 27 and the transverse web 29.

If seals 18 for linear rolling bearings of said type are to be mounted on the guide carriage 2, it is to be ensured that the seals 18 are aligned correctly with respect to the guide rail 2. Correct scraping contact of the scraper 3 against the guide rail 1 is otherwise not ensured. Positionally accurate alignment of the seal 18—be it here with scrapers with or without a housing—is complicated by the acting elastic restoring forces of the sealing lip 16a which bears against the guide rail 1, as is explained below. If one imagines that the sealing lip 16a in the region of the transverse web 29 is removed, then there is no contact of the seal against the guide rail 1 on the upper side of the guide rail 1. Only the two limbs 27 with their sealing lip 16a are then in scraping contact against the guide rail 1. In this case, the sealing lips 16a are compressed resiliently against the longitudinal sides of the guide rail 1. The acting pressure forces of the sealing lips 16a at both sides of the guide rail 1 are in force equilibrium, so that in this situation, correct alignment of the seal 18 in relation to the guide rail 1 is given.

In reality, however, additional elastic restoring forces of the sealing lip 16a act in the region of the transverse web 29, so that the seal 18 is resiliently forced or pulled upward away from the guide rail 1. This means that the sealing lips 16a, in the region of the lugs 28, are pressed to an increased degree against the ball groove 5, which forms the tension raceway, of the first rolling body channel 10 of the guide rail 1.

If the scraper 3 is fixed to the guide carriage 2 in this impermissible alignment, then the sealing lip 16a is subjected to increased wear, so that a reliable scraping action is not ensured. In order to ensure that no impermissible deformation of the sealing lip can occur when mounting the scraper onto the guide carriage, the scraper 3 is provided with a stop 31, as is shown in FIG. 1 with regard to the support plate 19. Said stop 31 is provided for abutment against the ball groove 5, of the guide rail 1, of the first rolling body channel. It can be seen from FIG. 1 that the stop 31 is formed on a lug 32. The support plate 19 has the integrally formed lugs 32 in each case on its two limbs. It can be seen from FIG. 2 that the sealing lip 16a projects slightly beyond the lug 32. If the seal 18 is positioned correctly with respect to the guide rail 1, it is therefore ensured that the lug 32 is out of contact with the guide rail 1. If, on account of the acting restoring forces of the sealing lip 16a against the upper side of the guide rail 1, the scraper 3 which has not yet been fixed to the guide carriage 2 is pulled upward, then this can occur only until the lug 32 abuts against the guide rail 1. In this abutment situation, it is ensured that the sealing lip 16a is not impermissibly deformed. A technician carrying out the assembly can additionally easily determine, on account of the abruptly increased resistance, that the stop 31 is already bearing against the guide rail 1.

The scraper 3 is provided with a further stop 33. Said stop 33 is formed on the projection 25, as already described further above, of the support plate 19. The sealing lip 16a projects beyond said stop 33 in the direction of the upper side of the guide rail 1. If, while being mounted onto the guide carriage 2, the scraper 3 is pressed too far downward, then the stop 33 abuts against the upper side of the guide rail 1. On account of the stop 33, the sealing lip 16a which bears against the upper side is not pressed impermissibly intensely against the upper side, and is therefore not damaged. Between the two described abutment situations, the scraper 3 is positioned correctly, preferably in a central position, and can be fixed to the guide carriage 2.

### LIST OF REFERENCE SYMBOLS

1 Guide rail
2 Guide carriage
3 Scraper
4 Limb
5 Ball groove
6 Raceway
7 Ball
8 Raceway
9 Ball groove
10 First load channel
11 Second load channel
12 Deflecting channel
12 Deflecting channel
14 Return channel
15 Return channel
16 Scraping system
16a Sealing lip
17 Housing
18 Seal
19 Support plate
19a Limb
20 Limb part
21 Limb part
22 Base part
23 First receptacle
24 Second receptacle
25 Projection
25a Transverse web
26 Recess
27 Limb
28 Lug
29 Transverse web
30 Slot
31 Stop
32 Lug
33 Stop

1. Linear rolling bearing, comprising a guide carriage which is mounted by means of rolling bearings on a guide rail, and having a scraper, arranged at least one of the two end sides of the guide carriage, for scraping foreign objects such as chips, dust and cooling liquids from the guide rail, with the scraper being in scraping contact, with the guide rail, wherein the scraper has a housing which optionally holds one or more preferably plate shaped, removable seals.

2. Linear rolling bearing according to claim 1, wherein the housing, which can be fastened in a detachable manner to the guide carriage, is of approximately unshaped design and can engage with its two limb parts around the guide rail, wherein the housing can be removed from the guide rail transversely with respect to the guide rail.

3. Linear rolling bearing according to claim 2, wherein the housing, as viewed in longitudinal section through the guide carriage, has an approximately u-shaped section profile which is open toward the guide rail, with the two limb parts forming a front wall and a rear wall of the housing, and with a base part, which connects the two limb parts, forming a peripheral wall of the housing.

4. Linear rolling bearing according to claim 1, wherein the housing has a rigid support plate as a support for the seal which is formed from flexible material.

5. Linear rolling bearing according to claim 4, wherein the housing has a first receptacle for the positionally accurate alignment of the support plate with respect to the guide rail.

6. Linear rolling bearing according to claim 4, wherein the housing has a second receptacle for the positionally accurate alignment of the seal with respect to the guide rail.

7. Linear rolling bearing according to claim 4, wherein the support plate and the seal engage into one another in a form-fitting manner at least one point.
